(19) United States
(12) Patent Application Publication
(10) Pub. No.: US 2009/0121183 A1
(43) Pub. Date: May 14, 2009

(54) ELONGATE PHOSPHORUS NANOSTRUCTURES

(75) Inventor: Max Whitby, London (GB)

Correspondence Address: OSHA LIANG L.L.P., TWO HOUSTON CENTER, 909 FANNIN, SUITE 3500, HOUSTON, TX, 77010, US

(73) Assignee: RGB RESEARCH LIMITED

(21) Appl. No.: 11/910,963

(22) PCT Filed: Apr. 7, 2006
(86) PCT No.: PCT/GB06/01277

§ 371 Date: Oct. 8, 2007

(30) Foreign Application Priority Data
Apr. 8, 2005 (GB) 0507199.8

(51) Int. Cl. C09K 3/00; B32B 5/02; C01B 25/02

(52) U.S. Cl. 252/183.14; 428/401; 423/322; 977/773

(57) ABSTRACT

Elongate phosphorus nanostructures, and methods of making them comprising the steps of forcing a phosphorus vapour and contacting said vapour with a metal catalyst under an inert atmosphere or under vacuum, at a suitable temperature are disclosed.

The present invention relates to tubular and/or rod-like nanostructures formed from elemental phosphorus and to methods of forming such structures.

Carbon nanotubes are well known; they have nanoscaled diameters and a structure that can be visualised as one or more layers of graphite rolled to form seamless cylinder(s). They may be synthesised by a number of different methods, including electric arc evaporation or laser ablation of graphite, and catalytic decomposition of organic vapours. The layered structure of graphite, with planes of carbon atoms held together by weak interplanar bonds, enables the formation of tubular structures, since there is a single low energy surface once the layer is curved into a cylinder.

These carbon nanotubes show either metallic or semiconducting properties depending upon exactly how the graphene sheet is rolled up. Existing methods of manufacture of carbon nanotubes have difficulty selectively forming either metallic or semiconducting nanotubes preferentially.

Due to their unusual electronic properties, extraordinary thermal conductivity and high tensile strength and flexibility, many applications of carbon nanotubes have been proposed, including use as components in nanoscale electronic circuits, capacitor/fuel cell electrodes, and transparent antistatic coatings. However, for a number of these applications, the controlled production of either metallic or semiconducting nanotubes is required or desired.

Synthesis of non-carbon nanotubes is also known. For example nanotubes formed from Bi, Sb, BₓC_{y}N_{z}, MoS₂, WS₂, TiO₂, NiCl₂, MoSe₂, NbS₂, GaN, InS, ZnS and V₂O₅ have all been described, although elemental nanotubes are rare.

The black allotrope of phosphorus is known to have a layered structure in its bulk form and is thought, by analogy with graphite, to be the most likely allotrope of phosphorus to form tubular nanoscale structures. Formation of the black phosphorus allotrope is conventionally performed by subjecting white phosphorus to high temperature and pressure according to the method of Bridgman (Phys. Rev. 3 187 (1914)) or by the catalytic action of mercury on white phosphorus using the method of Krebs et al. (Z. Anorg. Alig. Chemie 280 (1955) 119).

Phosphorus is known to form small clusters, for example P₈, P₁₂, and P₁₄ some of which have been isolated by A. Pfitzner et al. from their copper iodide adducts in an aqueous solution of potassium cyanide (Angew. Chem. Int. Ed. 2004, 43, 4228-4231).

Phosphorus nanotubes have been studied theoretically using density functional theory to minimise the energy of possible tubular forms of phosphorus (G. Seifert and E. Hernandez, Chem. Phys. Lett. 318, 355 (2000)). This study indicated that tubular structures of phosphorus are reasonably stable and might be expected to exist; they should have an average diameter distribution slightly larger than that of carbon nanotubes.

G. Seifert and T. Frauenheim published a related study of the theoretical stability of phosphorus nanotubes (J. Kor. Phys. Soc., 37(2), 89 (2000)) and I. Cabria and J. W. Mintmire have reported theoretical predictions of their electronic structure (Europhys. Lett. 65(1), 82 (2004)).

The present inventors have developed a controllable synthesis of phosphorus nanostructures.

In a first aspect, the present invention provides elongate phosphorus nanostructures. These elongate nanostructures may be hollow nanotubes or may be solid nanorods. Preferably the elongate nanostructures are nanotubes.

Where the phosphorus nanostructures are rod-like structures (“nanorods”), they are solid in cross section.

Where the phosphorus nanostructures are nanotubes, they have a channel inside them running substantially parallel to and preferably substantially along, the principle axis of the nanotube.

Both nanorods and nanotubes usually have a uniform circular or polygonal cross-section extended prismatically along the axis; nanotubes are often intrinsically capped at one or both ends; either structure may be terminated, usually at one end, by a catalytic particle. More complex structures, in which nanorods or nanotubes change diameter, geometry, twist, join or branch may be derived from the basic structures.

The phosphorus nanostructures may exist alone or may be present with extraneous material which is not in the form of nanostructures. In a second aspect, the present proposals relate to a material containing greater than 5%, preferably greater than 10% or greater than 20% or greater than 30%, more preferably greater than 50% or greater than 70% or greater than 80% and maybe up to 95% elongate phosphorus nanostructures. Preferably said extraneous material is bulk phosphorus and more preferably bulk black or bulk red phosphorus. Said extraneous material may comprise residual catalyst or unreacted starting materials or a side-product of the synthesis method.

Furthermore, the second aspect may relate to phosphorus, or preferably black phosphorus, containing above 10%, or above 25%, maybe above 50% and advantageously above 75% or above 90% nanostructures.

In the second aspect of these proposals, the phosphorus material present which is not present as elongate nanostructures may be present as any allotrope of phosphorus, such as white phosphorus, red phosphorus or black phosphorus and preferably as black phosphorus or red phosphorus.

In a third aspect, the present invention provides a method for forming elongate phosphorus nanostructures comprising the steps of forming a phosphorus vapour and contacting said vapour with a metal catalyst under an inert atmosphere or under vacuum, at a suitable temperature.

By “inert” atmosphere is meant an atmosphere having a reduced reactivity compared to air to the reactants and intermediates in the method for forming elongate phosphorus nanostructures and to the nanostructures themselves. Preferably this is a reduced-oxygen atmosphere, such as Ar gas. Preferably an “inert” atmosphere also has a reduced water content compared to air. More preferably an “inert” atmosphere as used herein is a reduced-oxygen atmosphere with a reduced water content compared to air, such as dry Ar gas.

In preferred methods, the concentration of oxygen in the inert atmosphere is less than 1%, preferably less than 0.1% and more preferably less than 0.01% by volume. The inert atmosphere may be any unreactive gas and may be selected from argon, carbon dioxide, nitrogen, helium, sulphur hexafluoride or a mixture of any two or more of these. Furthermore, the reaction may be performed under reduced pressure, for example less than 10⁻², less than 10⁻⁴ or less than 10⁻⁶ mbar.

Preferably, the inert atmosphere contains less than 1%, preferably less than 0.1%, more preferably less than 0.01% water by weight.

The preferences given for the inert atmosphere preferably relate to the atmosphere prior to reaction i.e. as put into the reaction vessel.

In the third aspect of the present proposals, the phosphorus vapour formed in the method used to synthesise elongate phosphorus nanostructures may be any vapour containing phosphorus atoms and is preferably P₄ vapour formed by vaporisation of white phosphorus.

Furthermore, in the methods of the third aspect of these proposals, the metal catalyst is preferably a metal catalyst that is liquid at the synthesis temperature. More preferably, the metal catalyst is liquid at the synthesis temperature when saturated with phosphorus.

The metal catalyst may be any metal but is advantageously a metal or alloy in which phosphorus is at least slightly soluble; under growth conditions of temperature and phosphorus concentration the catalyst metal or alloy is advantageously in its liquid form. More preferably the phosphorus saturated catalyst metal or alloy is in thermodynamic equilibrium with solid elemental phosphorus, preferably black phosphorus, at the synthesis temperature; ideally this equilibrium should exist over a wide range of temperatures and metal/phosphorus ratios. Preferably phosphorus does not readily react with the catalyst to form intermetallic or other compounds. Most preferably, the catalyst metal is selected from one or more of the following non-limiting group of metals, mercury, bismuth, lead and antimony.

The metal catalyst may be present as one or more fragments, a melt, a vapour, or may be finely divided solid or molten particles or droplets any of which may be dispersed on a high surface area or functional support.

Suitable high surface area supports may include silica, alumina, zirconia, zeolites, glass wool, quartz wool, aerosil™, aerogel, dispersed silica, carbon black, and other fumed or sol-gel derived oxides.

Functional supports may include wafers for electronics applications, such as single crystal silicon, sapphire, GaAs, InP or GaP.

Preferably the method of the third aspect of the invention is performed at elevated temperature. Advantageously, the method is performed under temperature and pressure conditions at which the rate of growth of the phosphorus nanostructures is greater than their rate of evaporation. In preferred aspects, the method is performed at above 45° C., preferably at above 275° C. and more preferably at above 350° C. The method of the third aspect may be performed at above 380° C., above 390° C. or above 410° C. Preferably the method of the third aspect of the proposals is performed at up to 600° C. and maybe higher and more preferably is performed at about 380° C.

In preferred methods, the ratio of metal catalyst to phosphorus, from which the phosphorus vapour is formed, in the reaction vessel is as low as possible to ensure growth of phosphorus nanostructures with a minimum catalyst contamination of the final product. Preferably the ratio of metal catalyst to phosphorus is between 1 to 1 and 1 to 1000, preferably to the lower end of this range such as between 1 to 100 and 1 to 1000, or between 1 to 500 and 1 to 1000 or may be between 1 to 800 and 1 to 1000 by weight. The concentration of metal catalyst present in the reaction vessel may be as low as 0.1-1 at. %. However, nanostructures may also be formed with ratios of metal catalyst to phosphorus between 1 to 1 and 1 to 100 and maybe between 1 to 1 and 1 to 50 or between 1 to 5 and 1 to 10 by weight.

Advantageously, the reaction is performed in a sealed vessel.

In a fourth aspect, the present invention provides phosphorus nanostructures obtainable by the methods of the third aspect.

The elongate phosphorus nanostructures of the present invention preferably have a relatively high aspect ratio. The aspect ratio of the nanostructures is defined as:

Aspect ratio=length/diameter

In preferred embodiments, the aspect ratio of the nanostructures is greater than 50, preferably greater than 100 and more preferably greater than 200 and may be up to or greater than 1000.

The diameter of the nanostructures of the present invention may vary both between samples and within a given sample. However, the diameter of the nanostructures preferably lies in a range. The lower limit of this range is preferably 1 nm, preferably 1.2 nm, more preferably 5 nm and even more preferably 20 nm. The upper limit of the range is preferably 5 μm, preferably 200 nm, more preferably 100 nm or may be 50 nm or 10 nm. All of these upper and lower values for the diameter range may be independently combined, i.e. the diameter range may have any one of the above mentioned lower limits and, independently, any one of the above mentioned upper limits.

Individual phosphorus nanostructures may have sections which take the form of nanorods and sections which take the form of nanotubes along their length.

The phosphorus nanostructures may take any elongate form. They may be substantially straight or may be curved or twisted in any direction. Furthermore, they may be branched structures. Preferably, the phosphorus nanostructures are substantially straight.

Whereas the hexagons of carbon atoms in the graphite structure lie flat within each plane, and hence carbon nanotubes have a ‘smooth’ outer surface, due to unpaired electrons on the phosphorus atoms, hexagonal rings formed by phosphorus atoms have a puckered conformation. This leads to phosphorus nanotubes having a ‘rough’ outer surface. In preferred aspects of these proposals, the phosphorus hexagons are either in the so-called “chair” or “boat” form.

The walls of phosphorus nanotubes can be thought of as being formed from an extended puckered hexagonal lattice of phosphorus atoms, as described above, rolled substantially into a cylinder.

Defects may occur in the substantially cylindrical nanotube walls due to the presence of rings of phosphorus atoms having more or less than six members, for example, 4, 5, 7 or 8 members, in the puckered hexagonal lattice. These defects can result in, for example, changes in the direction of propagation of the nanotube, changes in the diameter of the nanotube along its length or can provide point defects at which the physical properties of the nanotube, such as conductivity or chemical reactivity, may be different from the rest of the nanotube. These defects may also provide for closure of the nanotube through the formation of conical or hemispherical caps. Alternatively the ends of the nanotubes may remain open.

The phosphorus nanotubes may be formed from a single wall of phosphorus atoms or may have multiple walls of phosphorus cylinders arranged concentrically inside each other in a “Russian-doll” formation. Alternatively, the nanotubes may be formed from a single layer of phosphorus atoms rolled to have a spiral arrangement in cross-section. Preferably the nanotubes have either a single wall or multiple walls arranged inside each other. More preferably, the nanotubes have a single wall and have a diameter of between 1 and 10 nm.

The properties of the phosphorus nanotube may change depending on how the ‘sheet’ of phosphorus atoms is rolled up i.e. which crystallographic vector in the plane of atoms lies parallel to the axis of the nanotube. This may define some electronic properties of the nanotube. The phosphorus nanotubes preferably show semiconducting behaviour.

The nanorods of the present proposals may also preferably show semiconducting behaviour.

### FIGURES

FIG. 1 is a SEM image of a sample of the invention; and

FIG. 2 is a TEM image of a phosphorus fibre of the invention.

### EXAMPLE

White phosphorus was distilled in a quickfit apparatus fitted with a Leibig condenser. A heating tape was used to evaporate the white phosphorus. The apparatus was insulated with glass wool and aluminium foil wrapped. The distillate was discharged directly into chilled water.

1 g of the freshly distilled white phosphorus was added to a glass ampoule under an argon atmosphere. A crystalline sample of bismuth metal (Zhuzhou Kete Metals Test Works, PRC.) was hammered on a steel anvil to obtain small particles of bismuth. 0.1 g Pulverised bismuth metal was dropped on a plug of borosilicate glass wool and the plug of glass wool and bismuth metal was pushed into the neck of the ampoule under argon atmosphere. The ampoule was then flame sealed.

The sealed ampoule was placed in a steel bomb and the temperature was ramped up to 380° C. at a rate of 5° C./hour. The steel bomb was held at 380° C. for 2 days (3 days and 8 days were also used and produced the substantially the same results) and then the temperature was ramped down to room temperature over 8 hours.

Examination showed that the glass wool had darkened in colour during the experiment. Traces of red phosphorus were also seen coating the inner walls of the ampoule.

The glass wool was removed under dry-box conditions and washed with 2×5 ml CS₂ to remove any unreacted white phosphorus. The glass wool was then dried under vacuum.

Samples were prepared for study by transmission electron microscope (TEM) and scanning electron microscope (SEM) by two different methods:
1. A darkened sample of glass wool was sonicated in dry ethanol in a sonic bath. A sample of this suspension (2-3 drops) was dropped onto a copper electron microscopy sample grid coated with a holey carbon film (Agar Scientific) and allowed to dry.
2. Strands of the darkened sample of glass wool which supported visible black particles were carefully removed from the glass wool plug and were trapped in a butterfly electron microscopy sample grid.

The samples were studied using JEOL 2000FX and JEOL 2010FX microscopes fitted with an Oxford Instruments EDX detector.

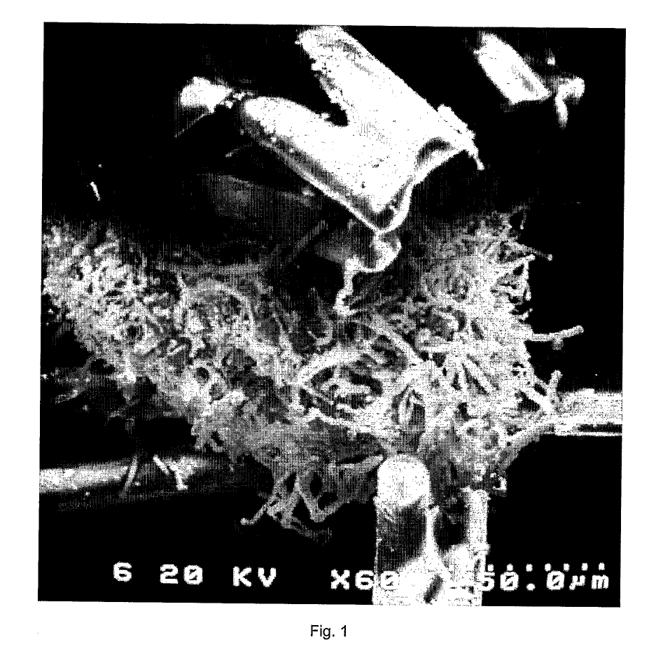

FIG. 1 shows an SEM image of a representative portion of this sample. The larger diameter fibres 1 are the glass wool support on which the sample was grown. The tangled mass of fibres 2 is made up from phosphorus nanostructures. Although it is not possible to observe the detailed structures of the nanostructures in the SEM, from TEM investigation of the product from this experiment, it is thought that these nanostructures are nanorods due to the diameter of the bismuth particles from which they were grown. The individual nanostructures are estimated to range in size from about 10 nm to around 5 μm in diameter. This is consistent with the approximate diameter distribution of the catalytic bismuth particles used in this experiment.

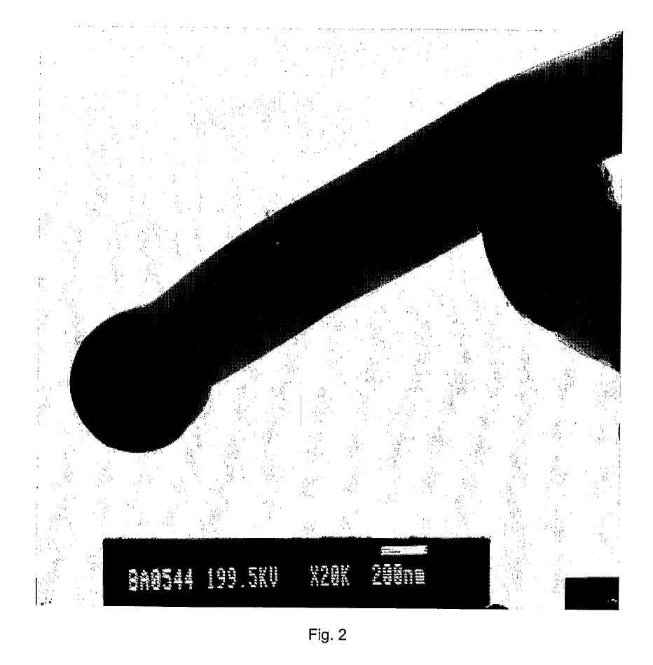

FIG. 2 shows a transmission electron microscope (TEM) image of a phosphorus fibre obtained from the product of this experiment. No internal void can be seen in FIG. 2 suggesting that the structure is a solid phosphorus nanorod.

In FIG. 2, the head 3 of the structure has a higher image contrast than the body 4 suggesting that the head 3 of the structure is made from a different, more dense, material than the body 4.

Energy dispersive X-ray (EDX) microanalyses of the structure shown in FIG. 2 were taken from the body 3 of the structure and the head 4 of the structure.

The EDX spectrum of the body 3 of the structure showed a strong signal for phosphorus indicating that it is composed largely from phosphorus atoms.

The EDX spectrum of the head 4 of the structure showed a strong Bi signal, along with a P signal. This indicates that the denser material at the head 4 of the structure is largely composed of Bi, maybe surrounded by a phosphorus outer layer.

The diameter of the body 3 of the phosphorus nanorod shown in FIG. 2 varies along its length between about 460 and about 550 nm.

The diameter of the bismuth head 4 shown in FIG. 2 is approximately 630 nm.

It is thought that the phosphorus nanostructures having lower diameters may be unstable in the harsh environment of the electron beam in the TEM and so may have degraded on TEM examination.

The nanostructures are stable for several days when stored in a closed container with a desiccant or in a closed vessel flushed with argon. However, it is thought that they deteriorate in atmospheric air over the course of a few days.

1. Elongate phosphorus nanostructures having a diameter of at least 1 nm.

2. Nanostructures according to claim 1, which are hollow nanotubes.

3. Nanostructures according to claim 1, which are solid nanorods.

4. Nanostructures according to claim 1, wherein the structure is terminated at one end by a catalytic particle.

5. A material comprising greater than 5%, of elongate phosphorus nanostructures according to claim 1.

6. The material according to claim 5, comprising greater than 50%, of elongate phosphorus nanostructures.

7. The material according to claim 5, wherein the remainder of the material comprises bulk phosphorus.

8. The material according to claim 7, wherein said bulk phosphorus is bulk black or bulk red phosphorus.

9. A method for forming elongate phosphorus nanostructures of claim 1, comprising the steps of forming a phosphorus vapour and contacting said vapour under suitable temperature and pressure conditions to maintain phosphorous in its vapour form and under an inert atmosphere or under vacuum with a metal catalyst in which phosphorous vapour is at least slightly soluble.

10. The method according to claim 9, wherein the inert atmosphere is a reduced-oxygen atmosphere.

11. The method according to claim 9, wherein the inert atmosphere is argon gas.

12. The method according to claim 9, wherein the phosphorus vapour is P₄ vapour formed by vaporisation of white phosphorus.

13. The method according to claim 9, wherein the metal catalyst is liquid at the synthesis temperature.

14. The method according to claim 9, wherein metal catalyst is selected from: mercury, bismuth, lead and antimony.

15. The method according to claim 9, wherein the method is performed at above 45° C.

16. Elongate phosphorus nanostructures having a diameter of at least 1 nm obtainable by the method of claim 9.
